(19) United States
(12) Patent Application Publication
(10) Pub. No.: US 2010/0318205 A1
(43) Pub. Date: Dec. 16, 2010

(54) SIGNAL PROCESSING APPARATUS AND SIGNAL PROCESSING METHOD

(75) Inventors: Kazunobu Ohkuri, Kanagawa (JP); Kohei Asada, Kanagawa (JP); Michiaki Yoneda, Kanagawa (JP); Tetsunori Itabashi, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/795,117

(22) Filed: Jun. 7, 2010

(30) Foreign Application Priority Data
Jun. 12, 2009 (JP) 2009-140967
Apr. 1, 2010 (JP) 2010-084805

(51) Int. Cl. G06F 17/00

(52) U.S. Cl. 700/94

(57) ABSTRACT

A signal processing apparatus includes: analog-to-digital conversion means that receives an analog detection signal acquired by detecting a movement of a diaphragm of a speaker, converts it into a digital signal by performing a first delta sigma modulation process, and outputs the digital signal; signal processing means that receives the digital detection signal output, generates a digital feedback signal, and outputs the digital feedback signal; synthesis means that converts an input digital audio signal to have a same sampling frequency as the feedback signal and then combines the input digital audio signal with the feedback signal as negative feedback; and digital-to-analog conversion means having a portion for a second delta sigma modulation process in which the digital audio signal after combination with the feedback signal is input, and the digital audio signal is converted into a digital signal and performing conversion of the digital audio signal into an analog signal.

### BACKGROUND OF THE INVENTION

1. Field of the Invention

The present invention relates to a signal processing apparatus that performs signal processing for an audio signal in accordance with a predetermined purpose and a method thereof.

2. Description of the Related Art

In the acoustic field, MFB (Motional FeedBack) has been known. The MFB is a technology for controlling, for example, the diaphragm of a speaker unit and an input audio signal to have the same movement by detecting the movement of the diaphragm of the speaker unit and applying negative feedback to the input audio signal. Accordingly, vibration, for example, near a low band resonant frequency f0 is damped, and thereby undesired influences on the low frequency-band such as so-called “boomy base” on the sense of hearing are suppressed.

A related art has been disclosed in JP-A-9-289699.

### SUMMARY OF THE INVENTION

However, signal processing systems for the MFB that have been practically used until now are configured by analog circuits.

In order to effectively acquire the advantages of the MFB, it may be needed to adjust a phase difference between a detection signal that is acquired by detecting the movement of a speaker diaphragm by using a sensor, a circuit, or the like and the sound reproduced from a speaker that is driven in accordance with the audio signal to which the detection signal is fed back within a predetermined value. When the phase difference does not fit into the predetermined value and exceeds an allowed range, for example, oscillation or the like can easily occur, and it is difficult for the MFB signal processing system to be practically used.

Thus, by substituting analog circuits with digital circuits, a change in or shift between characteristics or the operation modes can be easily performed without changing the constants of the physical components or replacing the physical components and thereby significant advantages can be acquired.

However, in order to configure the MFB signal processing system by using digital circuits, an A/D converter and a D/A converter are included in the input stage of the detection signal and the output stage of the audio signal after feedback. In consideration of the processing times of an A/D converter and a D/A converter that are widely used in the current situations, in a case where the A/D and D/A converters are used in the MFB signal processing system, the delay is considerably long. Accordingly, it is difficult to acquire effective control advantages. For example, in the fields for a military use, an industrial use, or the like, there are A/D converters and D/A converters having a little delay with a considerably high sampling frequency. However, such A/D converters and D/A converters are remarkably expensive and are not practical to be used in commercial devices. Accordingly, in the current situations, the MFB signal processing system is configured not by digital circuits but by analog circuits.

Therefore, there is a need for providing an MFB signal processing circuit that uses digital circuits and can be used with sufficient practicality.

According to an embodiment of the present invention, there is provided a signal processing apparatus including: analog-to-digital conversion means that receives an analog detection signal acquired by detecting a movement of a diaphragm of a speaker as input, converts the analog detection signal into a digital signal having a predetermined sampling frequency and a predetermined quantization bit rate that is equal to or greater than one bit by performing a first delta sigma modulation process, and outputs the digital signal; signal processing means that receives the digital detection signal output from the analog-to-digital conversion means as input, generates a digital feedback signal, and outputs the digital feedback signal; synthesis means that converts an input digital audio signal to have a same sampling frequency as the feedback signal and then combines the input digital audio signal with the feedback signal in a synthesis stage by combining the input digital audio signal to be reproduced as sound by the speaker with the feedback signal as negative feedback; and digital-to-analog conversion means that is formed to have at least a portion for performing a second delta sigma modulation process in which the digital audio signal after combination with the feedback signal is input, and the digital audio signal is converted into a digital signal having a quantization bit rate b (b<a) at a predetermined sampling frequency f1 by receiving the digital audio signal having the sampling frequency f1 and a quantization bit rate a after combination with the feedback signal output from the synthesis means and performing conversion of the digital audio signal into an analog signal.

Under the above-described configuration, an analog detection signal for the MFB is converted into a digital signal having a predetermined sampling frequency and a predetermined quantization bit rate in the first delta sigma modulation process. The signal processing means receives the digital detection signal of this signal format and generates a digital feedback signal, and the feedback signal is combined with an input digital audio signal for negative feedback. Then, in order to convert the audio signal of a predetermined quantization bit rate into an analog signal at the sampling frequency f1 after combination, a delta sigma modulation process in which a signal is converted into a signal of a quantization bit rate b (b<a) at the sampling frequency f1 is performed.

The configuration of such a signal processing system can be regarded as a configuration in which, for example, a decimation process in the A/D conversion process and an oversampling process in the D/A conversion process are omitted. Such processes may require corresponding processing times. Therefore, according to the configuration of the signal processing system of the embodiment of the present invention, the signal propagation time is decreased by not performing such processes.

By decreasing the signal propagation time as described above, a condition of a response speed for an MFB signal processing system can be satisfied. In other words, it can be easily implemented to practically use the digital MFB. As the digital MFB is practically used as described above, advantages such as implementation of a function that is difficult to be implemented by using analog circuits, high sound quality, and the like can be acquired.

### BRIEF DESCRIPTION OF THE DRAWINGS

FIG. 1 is a block diagram showing a basic configuration example of a digital MFB signal processing system.

FIGS. 2A to 2C are diagrams showing examples of signal processing configurations of an MFB-compliant digital signal processing unit of a DSP.

FIG. 3 is a block diagram showing a concrete configuration example of a digital MFB signal processing system that is naturally considered in current situations, in correspondence with the basic configuration shown in FIG. 1.

FIG. 4 is a block diagram showing a configuration example of an MFB signal processing system according to a first embodiment.

FIGS. 5A and 5B are diagrams showing configuration examples of digital filters included in an MFB-compliant digital signal processing unit according to an embodiment of the present invention.

FIG. 6 is a block diagram showing a configuration example of an MFB signal processing system according to a second embodiment.

FIG. 7 is a block diagram showing a configuration example of an MFB signal processing system according to a third embodiment.

FIG. 8 is a diagram showing an example in which the configuration of an MFB signal processing system according to an embodiment of the present invention is applied to a headphone (overhead type).

FIG. 9 is a diagram showing an example in which the configuration of an MFB signal processing system according to an embodiment of the present invention is applied to a headphone (in-ear type).

FIG. 10 is a diagram showing a configuration example of an analog MFB signal processing system.

### DESCRIPTION OF THE PREFERRED EMBODIMENTS

Hereinafter, made for implementing the present invention (hereinafter referred to as embodiments) will be described in the following order.

1. Configuration Example of Analog MFB Signal Processing System

2. Digital MFB Signal Processing System: Basic Configuration Example

3. Digital MFB Signal Processing System: Example of Practical Configuration in Consideration of the Current Situation

4. Digital MFB Signal Processing System: First Embodiment

5. Digital MFB Signal Processing System: Second Embodiment

6. Digital MFB Signal Processing System: Third Embodiment

7. Example Applied to Headphone

### 1. Configuration Example of Analog MFB Signal Processing System

Since acoustic devices such as speakers have physical mechanism units that can be moved in accordance with signals, these acoustic devices have relatively high distortion, for example, compared to a system having only electrical circuits. As a result, as a system, the follow-up capability for an input audio signal is not sufficient, which is recognized as an influential factor for deterioration of sound quality. Thus, technologies for improving the quality of reproduced audio by building a system that converts the actual driving state of a speaker such as the vibration behavior of the speaker or acoustic pressure, which is emitted into a space, into an electrical signal so as to be feedback to the system for reproducing an audio signal by using the speaker for reducing the distortion have been proposed. This is called MFB (Motional FeedBack). Described in more detail, by applying the MFB, unnecessary vibration of a speaker unit diaphragm, for example, near a low frequency-band resonant frequency f0 is suppressed. Accordingly, sound for which an undesirable influence on the low frequency band, so-called “boomy base” is suppressed can be acquired.

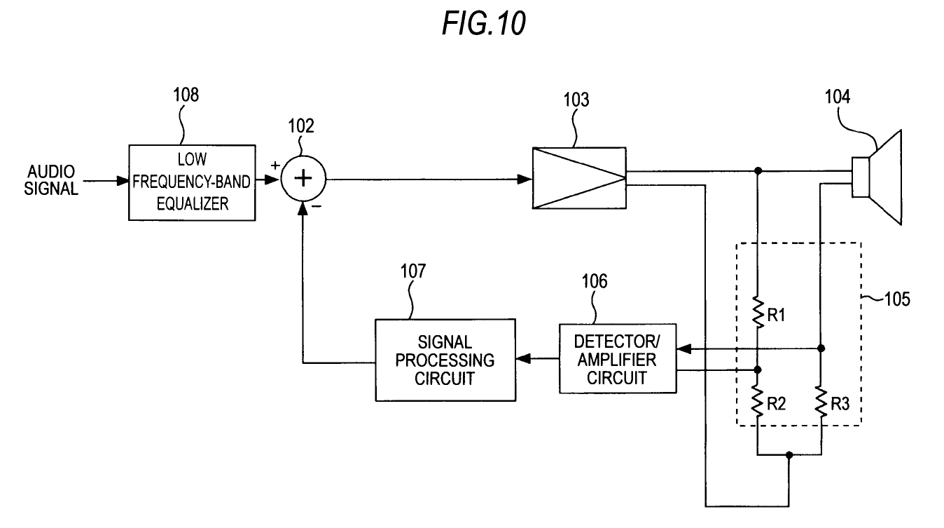

FIG. 10 shows an example for a case where a signal processing system (MFB signal processing system) corresponding to the MFB is configured by analog circuits. As shown in this figure, first, low frequency-band compensation, to be described later, is performed for an analog audio signal by a low frequency-band equalizer 108, and the analog audio signal is output to a synthesizer 102.

The synthesizer 102 receives an audio signal transmitted from the low frequency-band equalizer 108 and a signal transmitted from a signal processing circuit 107 as input. The signal transmitted from the signal processing circuit 107, as will be described later, is a feedback signal of the MFB that is acquired based on detection of a movement of a speaker unit 104. The synthesizer 102 combines the audio signal transmitted from the low frequency-band equalizer 108 with an inverted feedback signal. In other words, the audio signal is output by applying negative feedback by using a feedback signal.

The audio signal output from the synthesizer 102 is amplified at a power amplifier 103 and is output to the speaker unit 104. Accordingly, sound is reproduced in the speaker unit 104 in accordance with the audio signal.

A bridge circuit 105 that is configured by resistors R1, R2, and R3 is disposed in a driving signal line extending from the power amplifier 103 to the speaker unit 104 in accordance with the MFB, and the output of the bridge circuit 105 configured to be input to a detector/amplifier circuit 106.

The detector/amplifier circuit 106 amplifies a signal that is acquired by detecting a counter-electromotive force generated in an audio coil of the speaker unit 104 and outputs the amplified signal to a low pass filter (LPF) 107. Here, the counter-electromotive force detected by the bridge circuit 105 corresponds to detection of the speed of the diaphragm according to the movement of the diaphragm of the speaker unit 16.

The signal processing circuit 107 is configured to generate a feedback signal based on a detection signal transmitted from the detector/amplifier circuit 106. For example, the signal processing circuit 107 is configured by a filter circuit that is used for eliminating a noise component of the detection signal, a gain circuit that adjusts the gain of the feedback signal, and the like. The feedback signal generated by the signal processing circuit 107 is output to the synthesizer 102.

Accordingly, a negative feedback according to the movement of the diaphragm of the speaker unit 104 is applied to the input audio signal.

Thus, the speaker unit 104 is driven in accordance with the amplified output of the audio signal to which the negative feedback is applied. Accordingly, the control system of the MFB controls the speaker unit 104 to accurately vibrate in accordance with the waveform of the input audio signal. For example, this becomes an operation of applying damping with the low frequency band resonant frequency f0 used as the center. As a result, for example, as described above, unnecessary influence on the low frequency band is suppressed, and thereby reproduced sound is improved.

However, since damping is applied with the low frequency-band resonant frequency f0 used as the center as described above, power of the low frequency band tends to decrease as the frequency characteristics of the reproduced sound.

The low frequency-band equalizer 108 is disposed so as to compensate for a decrease in the power of the low frequency band. In other words, the low frequency-band equalizer 108 performs equalizing, so that the frequency characteristics targeted for the final reproduced audio can be acquired by correcting the low frequency band (band compensation) of the input audio signal, in which power decreases in accordance with the MFB, in advance.

### 2. Digital MFB Signal Processing System: Basic Configuration Example

The MFB signal processing system shown in FIG. 10 is an analog system. However, by configuring this system as a digital system, for example, many advantages as follows can be acquired.

First, in the feedback process, digital calculation is performed, for example, by using a digital filter or the like.

Accordingly, in principle, it is difficult for the feedback process to be influenced by noise from the periphery or the outside thereof, and therefore a process result having high accuracy can be expected. In addition, in a case where an analog circuit is used, it is difficult to acquire sufficiently high accuracy due to manufacturing variations in the electronic component devices. However, by performing digital calculation, it is difficult for such an error to occur in the calculation result due to such variations. Accordingly, for example, control for the performance of a product, which is originally designed, can be expected. In addition, a margin for control design for the amplitude, the phase, or the like does not need to be set in consideration of variations, and the margin for control design can be strictly set. Therefore, large feedback can be acquired, and high performance can be expected. In addition, by performing the calculation by using a digital filter, complicated filter characteristics, which are difficult to be designed by using an analog filter, can be acquired. Accordingly, for example, a more delicate control process can be performed. In addition, in a range in which the resources of a calculation processing unit such as a DSP are not insufficient, complicated characteristics can be set by software without incurring any increase in costs.

Furthermore, since the digital circuit can be controlled by software, it is easy to appropriately change the method of applying feedback such as the amount of feedback.

Accordingly, a control process having a wide application range can be performed by changing the control process so as to be matched with the characteristics of a connected speaker or the like.

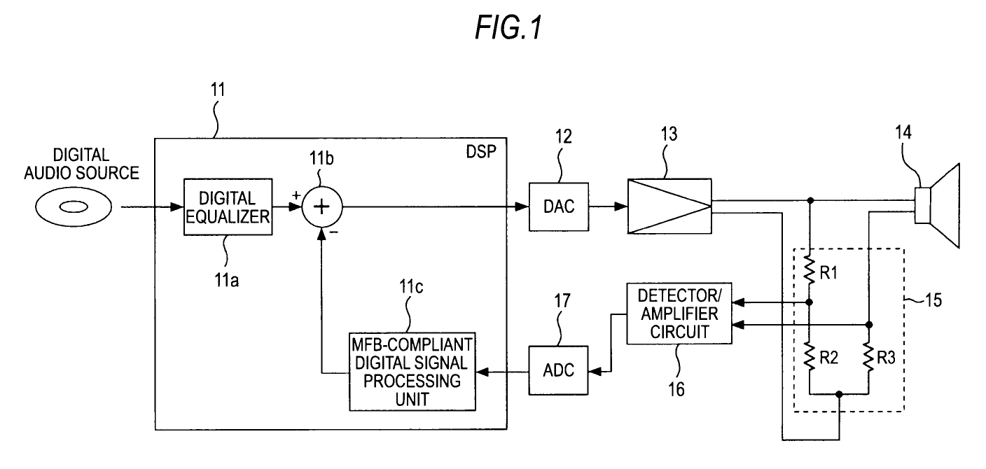

Thus, a configuration in which digital circuits are used in the MFB signal processing system will be described. FIG. 1 shows a basic configuration example for a case where the MFB signal processing system is configured by using digital circuits. The MFB signal processing system shown in the figure is basically configured by a DSP 11, a DAC 12, a power amplifier 13, a speaker unit 14, a bridge circuit 15, a detector/amplifier circuit 16, and an ADC 17.

The input audio signal for this case is a digital audio signal that is reproduced from a digital audio source. This digital audio signal is input to the DSP (Digital Signal Processor) 11.

In the DSP 11, signal processing units of a digital equalizer 11a, a synthesizer 11b, and an MFB-compliant digital signal processing unit 11c are formed. In addition, the signal processing function of the DSP 11 is implemented by a program, for example, called instruction or the like that is assigned to the DSP 11.

The digital audio signal input to the DSP 11, first, is input to the digital equalizer 11a. The digital equalizer 11a corresponds to the low frequency-band equalizer 108 shown in FIG. 10 and equalizes the digital audio signal in accordance with predetermined equalizing characteristics. Accordingly, the digital equalizer 11a compensates for the frequency band of the reproduced sound transmitted from the speaker unit 16, to which the MFB is applied, such that target frequency characteristics are acquired.

The digital audio signal output from the digital equalizer 11a is output to the synthesizer 11b. The synthesizer 11b is a portion for applying negative feedback to the input audio signal. The synthesizer 11b inverts a feedback signal output from the MFB-compliant digital signal processing unit 11c and combines the input digital audio signal with the inverted feedback signal.

In such a case, the digital audio signal as the output of the synthesizer lib is configured to be input to the DAC (D/A converter) 12 as the output of the DSP 11. The DAC 12 converts the input digital audio signal into an analog audio signal.

The power amplifier 13 amplifies the analog audio signal transmitted from the DAC 12 and supplies the amplified analog audio signal to the audio coil of the speaker unit 14 as a driving signal. Accordingly, the sound of a digital audio source is reproduced from the speaker unit 14.

The bridge circuit 15, similarly to the bridge circuit 105 shown in FIG. 10, is configured by connecting resistors R1, R2, and R3 to a driving signal line extending from the power amplifier 13 to the speaker unit 14 as shown in the figure. The detector/amplifier circuit 16, similarly to the detector/amplifier circuit 106 shown in FIG. 10, receives a signal from a sensor portion of the bridge circuit 15 and generates a detection signal corresponding to the speed of movement of the speaker unit 14.

In such a case, the analog detection signal output from the detector/amplifier circuit 16 is converted into a digital signal by the ADC (A/D converter) 17 and is input to the MFB-compliant signal processing unit 11c of the DSP 11.

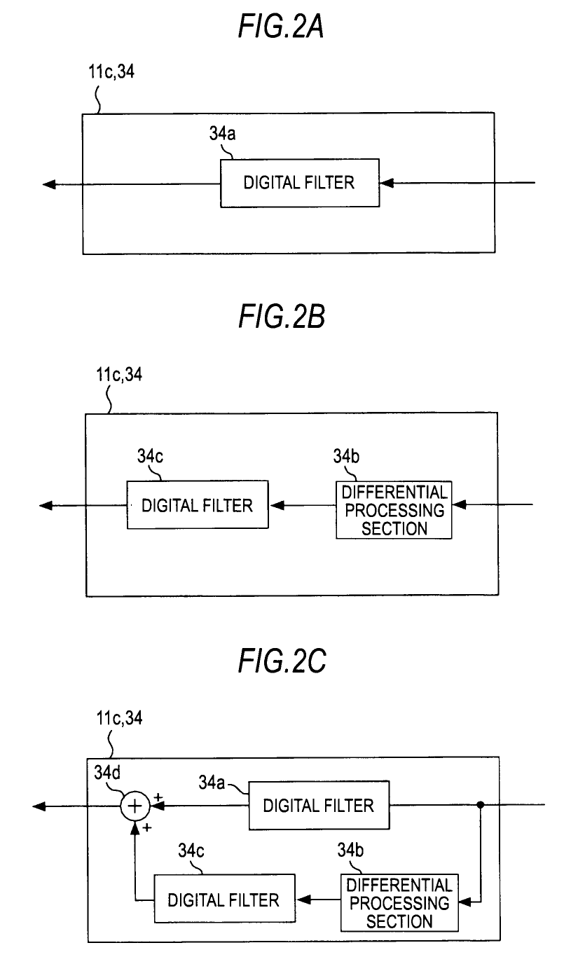

The MFB-compliant signal processing unit 11c corresponds to the signal processing system as so-called a feedback circuit and generates a feedback signal from the input digital detection signal. FIGS. 2A to 2C show three examples of the configuration of the MFB-compliant signal processing unit 11c on the premise that a detection signal in proportion to the speed is acquired by the bridge circuit 15. As a feedback control method for the MFB, speed control, acceleration control, displacement control, and the like are known. However, here, the configurations corresponding to cases where the speed control, the acceleration control, and a combination type of the speed control and the acceleration control are employed in accordance with inclusion of the bridge circuit 15 are represented by FIGS. 2A, 2B, and 2C.

First, FIG. 2A represents a configuration in which a digital filter 34a is provided as a configuration corresponding to the speed control. The digital filter 34a, for example, is configured as an FIR (Finite Impulse Response) type or an IIR (Infinite Impulse Response) type. The signal processing function of the digital filter 34a, for example, is implemented by an LPF that eliminates an unnecessary frequency band component corresponding to a noise from a detection signal corresponding to the speed, a gain circuit that sets the gain for the output of a feedback signal, and the like. By applying feedback to the input audio signal by using the feedback signal corresponding to the speed, an operation of braking the diaphragm of the speaker unit 14 in accordance with the detected speed can be acquired as the MFB. In other words, the MFB operation by using the speed control can be acquired.

FIG. 2B is a configuration corresponding to the acceleration control, and the configuration includes a differential processing section 34b and a digital filter 34c as shown in the figure. The differential processing section 34b calculates the differential of the input detection signal and outputs a resultant signal. As described above, the detection signal acquired from the bridge circuit 15 represents the speed of the speaker diaphragm. Accordingly, by calculating the differential of the detection signal corresponding to the speed, a signal representing the acceleration of the speaker diaphragm is calculated. In other words, a detection signal corresponding to the acceleration can be acquired from the detection signal corresponding to the speed by the differential processing section 34b. The digital filter 34c performs signal processing, for example, as shown in FIG. 2A for the signal output from the differential processing section 34b and outputs a resultant signal as a feedback signal corresponding to the acceleration control. By applying feedback to the input audio signal by using the feedback signal, the operation of the MFB can be acquired as the acceleration control.

FIG. 2C is a configuration in which speed control and acceleration control are used together, and the configuration includes a digital filter 34a, a differential processing section 34b, a digital filter 34c, and a synthesizer 34d. The digital filter 34a is disposed in correspondence with the speed control as shown in FIG. 2A, and the differential processing section 34b and the digital filter 34c correspond to the acceleration control as shown in FIG. 2B.

In such a case, the detection signal is branched so as to be input to a system configured by the digital filter 34a and a system configured by the differential processing section 34b and the digital filter 34c. A feedback signal corresponding to the speed control is output from the digital filter 34a, and a feedback signal corresponding to the acceleration control is output in accordance with signal processing performed by the differential processing section 34b and the digital filter 34c. The synthesizer 34d combines the feedback signals corresponding to the above-described speed-control and acceleration control and outputs a resultant signal. In other words, in such a case, a feedback signal output from the MFB-compliant digital signal processing unit 11c is acquired by combining a speed control component and an acceleration control component together. By applying feedback to the input audio signal by using the feedback signal, as the operation of the MFB, control corresponding to the speed and control corresponding to the acceleration are acquired together.

In addition, as shown in FIG. 1, by disposing the bridge circuit 15 as a sensor for detecting the movement of the speaker diaphragm, first, the speed is configured to be detected based on the movement of the speaker diaphragm. Other configurations of the sensor for the MFB may be considered. For example, as a sensor for detecting the speed, a sensor coil separated from the audio coil of the speaker unit may be disposed so as to detect a current acquired in the sensor coil. In addition, a detecting signal corresponding to detected acoustic pressure may be treated as the acceleration of the diaphragm of the speaker unit by detecting the acoustic pressure applied from the speaker unit by using a microphone. Furthermore, the acceleration may be detected by disposing a physical acceleration sensor in the diaphragm of the speaker unit. In addition, a case where a detection signal corresponding to a displacement of the diaphragm of the speaker unit is acquired by detecting the movement of the diaphragm of the speaker unit based on a change in the electrostatic capacitance may be considered. Even in a case where the MFB signal processing system is configured by digital circuits as shown in FIG. 1, the configuration of the sensor is not particularly limited, and any configuration may be used. This point also applies to a case where an MFB signal processing system according to an embodiment of the present invention to be described later is configured.

### 3. Digital MFB Signal Processing System: Example of Practical Configuration in Consideration of the Current Situation

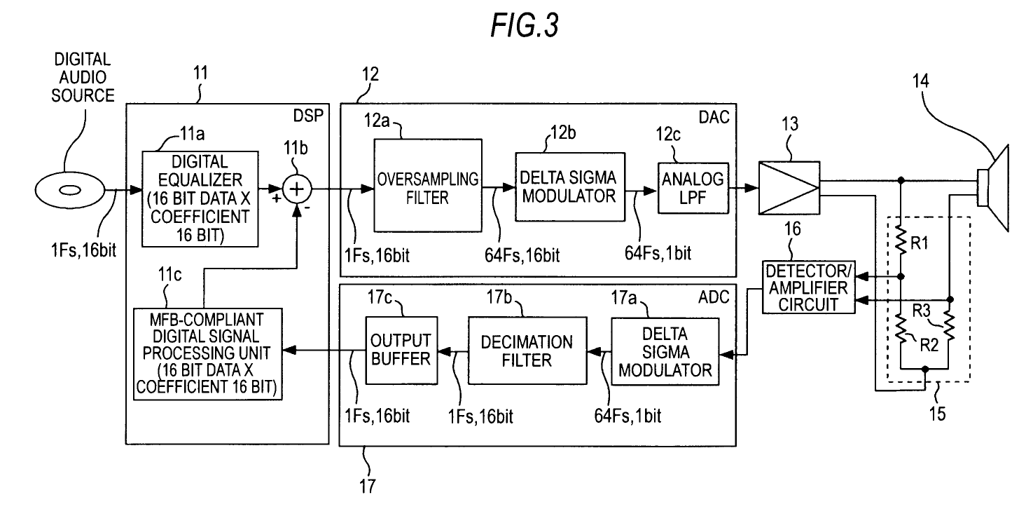

FIG. 3 shows a practical configuration example that is naturally considered for a case where an MFB signal processing system is actually built by using digital devices known in the current situation under the basic configuration represented in FIG. 1 and FIGS. 2A to 2C. In descriptions made hereinafter, a reference sampling frequency denoted by Fs (1 Fs) is assumed to represent the sampling frequency of the digital audio signal as a digital audio source to be originally listened to by using a headphone device. As a practical example of the digital audio source here, there is an audio source having Fs=44.1 kHz and 16-bit quantization bit rate, similarly to a digital audio signal recorded in a CD (compact disc). In the figure, the same reference numeral is assigned to each portion that is the same as that shown in FIG. 1. The entire configuration and a portion formed by analog devices shown in this figure are the same as those described with reference to FIG. 1, and thus a description thereof is omitted here.

First, an ADC 17 will be described. The ADC 17 for this case, for example, is actually configured by one component or device. The ADC 17 receives an analog detection signal that is output from a detector/amplifier circuit 16 as input, converts the detection signal into a digital signal (PCM signal) digitalized (quantized) with the sample frequency of 1 Fs and a 16-bit quantization bit rate ([1 Fs and 16 bit]) that are the same as those of a digital audio source to be described later, and outputs the converted digital signal.

As a configuration for implementing such a function, the ADC 17 of this case, as shown in the figure, includes a delta sigma (ΔΣ) modulator 17a, a decimation filter 17b, and an output buffer 17c. The analog audio signal input to the ADC 17, first, is converted into a digital signal of [64 Fs (=2.8224 MHz) and 1 bit] by the delta sigma modulator 17a. This digital signal of [64 Fs and 1 bit] is converted into a digital signal of [1 Fs, 16 bit], for example, by passing the digital signal through the decimation filter 17b of the FIR (Finite Impulse Response) and is amplified further in a digital signal stage by an output buffer 17c. In this case, the output of this output buffer 17c is input to an MFB-compliant digital signal processing unit 11c of the DSP 11, as the output of the ADC 17.

The DSP 11 of this example is, for example, provided as one chip component. The DSP 11 has a digital equalizer 11a, a synthesizer lib, and an MFB-compliant digital signal processing unit 11c, similarly to FIG. 1, for the signal processing function, for example, according to an instruction (program).

The MFB-compliant digital signal processing unit 11c of this case, for example, has the configuration of an FIR filter. The MFB-compliant digital signal processing unit 11c is configured to receive a signal of a 16 bit quantization bit rate as input and to multiply the signal by a 16-bit coefficient. Accordingly, the format of the feedback signal that is output from the MFB-compliant digital signal processing unit 11c is [1 Fs and 16 bit], which is the same as that of the input detection signal.

In addition, while a digital audio source signal is input to the DSP 11, the signal of the digital audio source is a digital audio signal of the format of [1 Fs and 16 bit]. Similarly to the digital equalizer 11a that receives the digital audio source signal as input or the MFB-compliant digital signal processing unit 11c, the DSP 11, for example, is configured as an FIR filter. The DSP 11 is configured as a calculation circuit that receives a signal of a 16-bit quantization bit rate as input and multiplies the input signal by a 16-bit coefficient. Accordingly, the digital audio signal after correction of the frequency characteristics that is output from the digital equalizer 11a is in the format of [1 Fs and 16 bit].

The synthesizer 11b combines the digital audio signal and an inverted feedback signal together that are in the format of [1 Fs and 16 bit], as a process of applying negative feedback. Accordingly, the digital audio signal that is output from the synthesizer 11b to the DAC 12 is also in the format of [1 Fs and 16 bit].

This DAC 12, for example, is provided as one chip component. The DAC 12 converts the digital signal of a format converted by the ADC 17 described above into an analog signal. As the internal configuration of the DAC 12, for example, as shown in the figure, an oversampling filter 12a, a delta sigma modulator 12b, and an analog LPF (Low Pass Filter) 12c are included.

An oversampling process is performed for the digital signal of [1 Fs and 16 bit] input to the DAC 12 by the oversampling filter 12a so as to convert the input digital signal into a digital signal of the format of [64 Fs and 16 bit], and the converted digital signal is output to the delta sigma modulator 12b. The delta sigma modulator 12b converts the input digital signal into the format of one bit. In other words, the delta sigma modulator 12b converts the input digital signal into a digital signal of the format of [64 Fs and 1 bit] and outputs the converted digital signal. By passing the digital signal of [64 Fs and 1 bit] that is the output of the delta sigma modulator 12b through an analog LPF 12c, an analog audio signal is acquired as the output of the analog LPF 12c. In other words, the digital audio signal of [1 Fs and 16 bit] input to the DAC 12 is converted into an analog audio signal, and the converted analog audio signal as the output of the DAC 12 is input to the power amplifier 13.

In the configuration shown in FIG. 3, for example, an A/D converter, a DSP, a D/A converter, and the like that can be easily acquired for commercial use are used. The configuration shown in FIG. 3 is a configuration naturally considered first in a case where an actual digital MFB system (MFB signal processing system), for example, that corresponds to an audio source such as a CD is to be built in the current situation.

However, it is known that it is actually difficult to acquire a sufficient effect of the MFB control for practical use under the above-described configuration. The reason for this is that the signal processing time, that is, delays of input/output time intervals of actual devices as the ADC 17 and the DAC 12 is quite long. Originally, such devices are configured in consideration of uniformly processing an audio signal as an audio sound source such as an ordinary music composition. Accordingly, even in a case where there is a delay in accordance with signal processing, there is no problem. However, in a case where such devices are used in an MFB signal processing system, the delay is significantly long. In other words, in the entire MFB signal processing system that is configured by using such devices, there is a long delay in a time (response speed) until an audio signal to which feedback is applied is reproduced and output as a sound from the speaker unit 14 after a detection signal is acquired by the detector/amplifier circuit 16 in accordance with the output from the bridge circuit 15. The feedback operation as the MFB is considerably delayed due to the above-described delay, and it is difficult to actually acquire a good result of the control. For example, in a case where the delay of the ADC 17 alone for the sampling frequency of 44.1 KHz and below is a time corresponding to 40 samples, the phase delay of a signal having the frequency equal to or higher than about 550 Hz due to the above-described delay alone is equal to or more than 180 degrees. Accordingly, the phase is rotated by that amount through only the A/D conversion. Therefore, as a filtering process is additionally performed through the LPF (Low Pass Filter), BPF (Band Pass Filter), and the like, the rotation of the phase further increases. In a case where the delay is increased up to that amount, it is difficult to acquire the effect of control by using the MFB, and a phenomenon such as an acoustic reproduction action may easily occur. Thus, in order to maintain the stability of the system, the frequency band targeted for the MFB control is considerably narrowed. In other words, in the configuration shown in FIG. 3, it is difficult to acquire the effect of the MFB that is sufficient for practical use. This is the reason that only the analog-type MFB has been practically used until now.

However, as described above, there are significant advantages of employing a digital MFB signal processing system. Thus, as an embodiment of the present invention, a configuration in which a digital MFB signal processing system is employed for solving the above-described problem of delay so as to be practically used is proposed, as will be described hereinafter.

### 4. Digital MFB Signal Processing System: First Embodiment

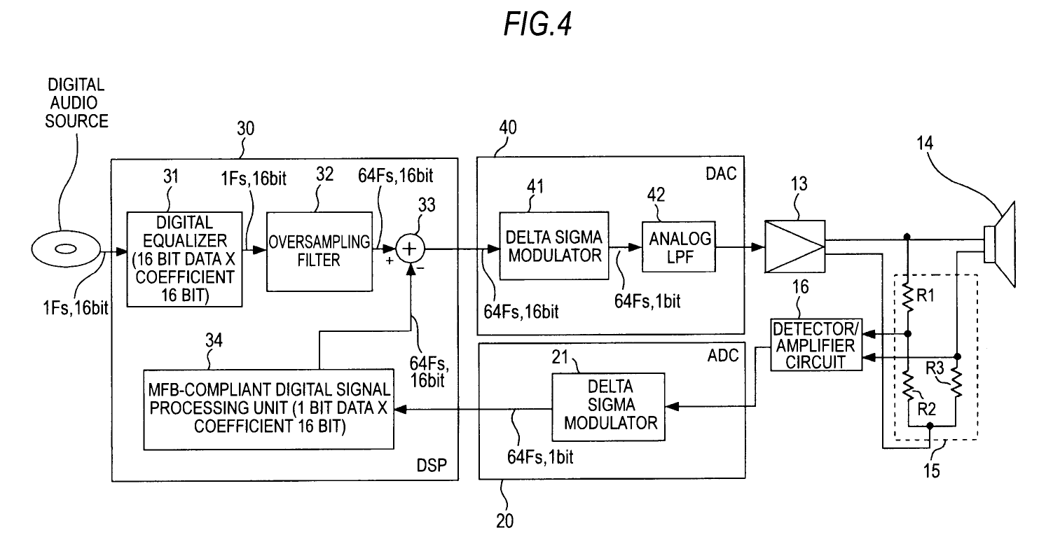

FIG. 4 shows a configuration example of an MFB signal processing system according to a first embodiment. Here, in the figure, the same reference numeral is assigned to each same portion as that shown in FIG. 3, and description thereof will be omitted or simplified. In the configuration shown in the figure, first, an ADC 20 is provided instead of the ADC 17 shown in FIG. 3. The ADC 20, for example, is configured by one chip component. As shown in the figure, the ADC 20 is configured to include only a delta sigma modulator 21. The input analog signal is converted into a digital signal of the format of [64 Fs (=2.8224 MHz) and 1 bit] by the delta sigma modulator 21. Then, the output of the delta sigma modulator 21 is input to a DSP 30 as the output of the ADC 20.

The DSP 30, for example, is configured by one chip component, as well. The DSP 30 for this case, as shown in the figure, is configured to include a digital equalizer 31, an oversampling filter 32, a synthesizer 33, and an MFB-compliant digital signal processing unit 34.

The MFB-compliant digital signal processing unit 34 shown in FIG. 4, similarly to the MFB-compliant digital signal processing unit 11c of the DSP 11 shown in FIG. 3, has a signal processing function as a feedback circuit that generates a feedback signal from a detection signal. For the MFB-compliant digital signal processing unit 11c of the DSP 11 shown in FIG. 3, the format of the digital audio signal, which is input or output, is [1 Fs and 16 bit]. On the other hand, for the MFB-compliant digital signal processing unit 34 shown in FIG. 4, the format of an input signal is [64 Fs and 1 bit], and the format of an output is [64 Fs and 16 bit] by performing calculation using a 16-bit coefficient. The MFB-compliant digital signal processing unit 34, for example, may be configured by an FIR digital filter. Accordingly, the output of the MFB-compliant digital signal processing unit 34 is formed as multiple bits. The quantization bit rate as the multiple bits is set to 16 bits here. The reason for configuring the format of the feedback signal output from the MFB-compliant digital signal processing unit 34 to be [64 Fs and 16 bit], as can be understood from the description below, is in order to allow the format of the feedback signal to coincide with the format of a digital audio signal of [64 Fs and 16 bit] in the synthesis stage.

The digital equalizer 31 shown in FIG. 4, similarly to the digital equalizer 11a shown in FIG. 3, receives a digital audio source signal (digital audio signal) of the format of [1 Fs and 16 bit] as input and performs an equalization process for the digital audio source signal so as to compensate for the low frequency-band by performing calculation using a 16-bit coefficient. Then, the digital equalizer 31 outputs an audio signal of the format of [1 Fs and 16 bit] that is the same as that of the input.

In such a case, the audio signal of [1 Fs and 16 bit] that is output from the digital equalizer 31 is input to the oversampling filter 32. The oversampling filter 32 for this case converts the digital audio signal from the format of [1 Fs and 16 bit] to the format of [64 Fs and 16 bit]. Here, the reason for converting the digital audio source signal into the format of [64 Fs and 16 bit] is in order to allow the output digital audio signal to have the same digital signal format as that of the feedback signal output from the MFB-compliant digital signal processing unit 34.

The synthesizer 33 receives the digital audio source signal and the feedback signal that have the same format of [64 Fs and 16 bit] as described above, as input. Then, the synthesizer 33 combines the digital audio source signal with the feedback signal of which the phase is inverted and outputs a digital audio signal to which feedback is applied. The output of the synthesizer 33 is input to the DAC 40 as the output of the DSP 30.

The DAC 40 shown in FIG. 4, for example, is configured by one chip component. The DAC 40 includes a delta sigma modulator 41 and an analog LPF 42. It can be noticed that the oversampling filter 12a is omitted in the DAC 40 by comparing the DAC 40 with the DAC 12 shown in FIG. 3.

The delta sigma modulator 43 receives the digital audio signal of [64 Fs and 16 bit], which is output from the synthesizer 33 of the DSP 30, as input, converts the digital audio signal into a digital signal of [64 Fs and 1 bit] by performing one-bit converting process, and outputs the converted digital signal. The digital signal as the output of the delta sigma modulator 41 is converted into an analog audio signal through the analog LPF 42, and this analog audio signal output from the DAC 40. The analog audio signal acquired as described above is amplified by the power amplifier 13 and is used for driving the speaker unit 14.

Here, in the configuration shown in FIG. 4, a feedback signal is generated from a detection signal detected by the bridge circuit 15 and the detector/amplifier circuit 16. The operation of a digital signal processing system performed until the input audio signal with which the feedback signal (inverted) is combined is output as sound by the speaker unit 14 will be focused. Then, the digital signal processing system may be regarded to perform digital signal processing in the order of the delta sigma modulator 21, the MFB-compliant digital signal processing unit 34, the synthesizer 33, the delta sigma modulator 41, and the analog LPF 42. When being compared with the case of FIG. 1, this can be regarded as not going through the decimation filter disposed on the A/D conversion side and the oversampling filter disposed on the D/A conversion side.

As described above, in the configuration shown in FIG. 3, delays in the ADC 17 and the DAC 12 are significant. Actually, as a factor causing such delays, a delay due to the decimation filter 17b is dominant in the ADC 17, and a delay due to the oversampling filter 12a is dominant in the DAC 12. This embodiment is configured by focusing on this. In other words, in order to exclude the influence of delays in the decimation filter disposed on the A/D conversion side and the oversampling filter disposed on the D/A conversion side in the MFB digital signal processing system, the input and the output of the MFB-compliant digital signal processing unit 34 of the DSP 30 are directly connected to the delta sigma modulator 21 (ADC 21) and the delta sigma modulator 41 (inside the DAC 40), respectively. Accordingly, the dominant factors causing the delays of the D/A conversion side and the A/D conversion side of the MFB signal processing system are excluded, and thereby the delay in the signal processing for the MFB is markedly decreased. Accordingly, the above-described rotation of the phase is decreased. As a result, the effect of MFB control that is sufficient for practical use can be acquired. In other words, a digital MFB system that can be practically used can be acquired.

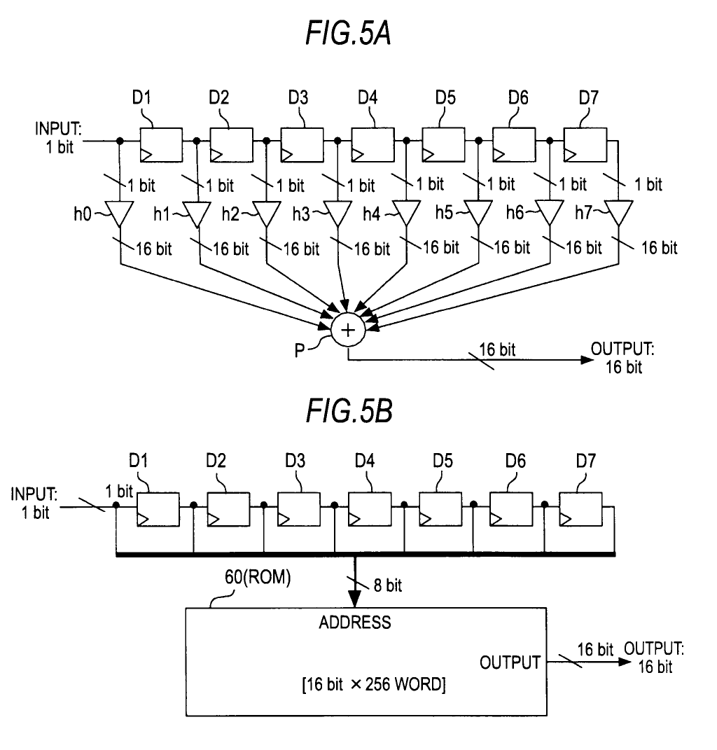

In addition, in this embodiment, the MFB-compliant digital signal processing unit 34 is configured to have a little delay, and thereby an MFB signal processing system that has high practicability and high performance can be acquired. In order to configure the MFB-compliant digital signal processing unit 34 having a little delay, for example, a configuration described below may be considered to be used. First, generally, in a case where an FIR digital filter (FIR filter) is employed as the MFB-compliant digital signal processing unit 34, a configuration as shown in FIG. 5A is employed. In other words, in a case where the MFB-compliant digital signal processing unit 34 is configured by using an 8-tap FIR filter, as shown in the figure, first a shift register is formed by connecting seven delay devices D1 to D7 together in series. In addition, coefficient devices h0 to h7 that receive input data of the delay device D1 and output data of the delay devices D1 to D7, which are the outputs of the shift register, as inputs and perform multiplication for the data by using predetermined coefficients and an adder P that adds the outputs of the coefficient devices h0 to h7 together are disposed. In such a case, since the input digital signal is in the format of [64 Fs and 1 bit], the delay devices D1 to D7 and the coefficient devices h0 to h7 receive signals of one bit. In addition, in order to configure the output to be in the format of [64 Fs and 16 bit], coefficients set in the coefficient devices h0 to h7 are configured to be 16 bits as multiple bits, and thereby the output of the coefficient devices h0 to h7 are configured to be 16 bits. Then, the outputs of the coefficient devices h0 to h7 are added together by the adder P.

The configuration shown in FIG. 5A can be regarded as a configuration in which 8-bit data acquired by arranging the input data of the delay device D1 and the output data of the delay devices D1 to D7 is converted into a bit pattern of 16 bits, which is in linear correspondence with the bit pattern, and is output. Based on the above-described configuration, the MFB-compliant digital signal processing unit 34 can be configured by delay devices D1 to D7 and a ROM 60, as shown in FIG. 5B. In FIG. 5B, 8-bit data is formed by input data of the delay device D1 of one bit and the output data of each of the delay devices D1 to D7 of one bit, which are regarded as the output of the shift register, at the same timing, and the address of the ROM 60 is configured to be designated based on the 8-bit data. Since there are 256 bit patterns that can be represented by 8 bits, 0 to 255 is set as the addresses of the ROM 60. Then, in the ROM 60, appropriate bit patterns of 16 bits are stored in association with addresses of 0 to 255. By employing such a configuration, an operation of reading data of a 16-bit bit pattern corresponding to a designated address from the ROM 60 by designating an address of 0 to 255 to the ROM 60 at a timing for each one sample can be acquired. The 16-bit data read out as described above is configured to be the output of the MFB-compliant digital signal processing unit 34 according to this embodiment. Under such a configuration, the coefficient devices h0 to h7 and the adder P as shown in FIG. 5A are omitted. Accordingly, such a process is implemented by reading the ROM 60 at a designated address, and thereby the circuit scale is simplified.

In addition, as another configuration for implementing the MFB-compliant digital signal processing unit 34 having a little delay, for example, there is a configuration using a minimum phase-shift filter. This, for example, can be implemented by setting the pattern of coefficients to be set in the coefficient devices h0 to h7 to be in the minimum phase shift pattern under the configuration shown in FIG. 5A. Alternatively, another configuration using an IIR (Infinite Impulse Response) digital filter may be considered. The IIR filter has the characteristic that the amount of resultant delay is small.

In addition, in this embodiment, the sampling frequency of the output signal of the MFB-compliant digital signal processing unit 34 is set as below. First, the DSP 10 of this case receives the digital audio source signal (digital audio signal) in the format of [1 Fs and 16 bit] as input and converts the digital audio source signal into the format of [64 Fs and 16 bit] through an oversampling process performed by the oversampling filter 32. The formats of the input and the output of the synthesizer 33 are not changed. In other words, the sampling frequency of the digital audio signal to be output from the DSP through oversampling is set to 64 Fs.

Accordingly, the delta sigma modulator 41 of the DAC 40 to which the digital audio signal output from the DSP 30 is input is configured so as to convert a signal of the format of [64 Fs and 16 bit] into a signal of one bit. Thus, the output of the delta sigma modulator 41 has the format of [64 Fs and 1 bit]. In addition, in this embodiment, the feedback signal output from the MFB-compliant digital signal processing unit 34 is input to the synthesizer 33 not through the oversampling filter. Accordingly, the format of the feedback signal is configured to be [sampling frequency and quantization bit rate] that is in correspondence with the input (it corresponds to the output of the oversampling filter through the synthesizer 33) of the delta sigma modulator 41. Thus, the format of the feedback signal output from the MFB-compliant digital signal processing unit 34 is configured to be [64 Fs and 16 bit] in FIGS. 2A and 2B. In addition, in terms of the sampling frequency, the feedback signal output from the MFB-compliant digital signal processing unit 34 is set to be the same as the output signal of the delta sigma modulator 41. In addition, the sampling frequency after oversampling here, that is, the sampling frequency of the output signal (feedback signal) of the MFB-compliant digital signal processing unit 34 according to this embodiment is set to 64 Fs. However, the sampling frequency after oversampling is not limited thereto. In other words, a frequency value that is higher than 1 Fs, which is the sampling frequency of the digital audio signal (PCM (Pulse Code Modulation) signal) as the digital audio source handled here, and is sufficient for acquiring a reproduced sound, for example, having the quality equal to higher than a predetermined level may be set. Described in detail, when the sampling frequency of the PCM signal as the digital audio source is denoted by Fs, the sampling frequency (the sampling frequency after oversampling) of the feedback signal is set to value that has, for example, the lower limit of 2 Fs and has the coefficient of Fs represented by power of two. In practical use, it is preferable that the sampling frequency after oversampling is set to a value that is equal to or greater than 4 Fs.

### 5. Digital MFB Signal Processing System: Second Embodiment

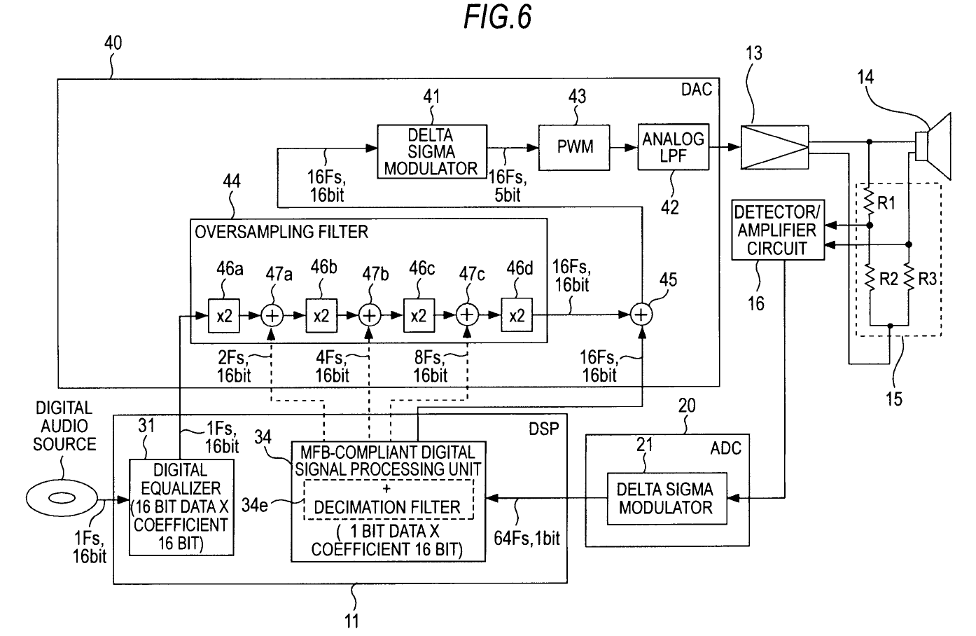

Next, a configuration example of an MFB signal processing system according to a second embodiment will be described with reference to FIG. 6. In the figure, the same reference numeral is assigned to each same portion as that shown in FIG. 4, and description thereof is omitted here. First, the basic configuration according to the second embodiment will be described. A DAC 40 shown in this figure is basically configured by an oversampling filter 44, a synthesizer 45, a delta sigma modulator 41, a PWM (Pulse Width Modulation) modulator 43, and an analog LPF 42. This configuration is acquired by inserting the PWM modulator 43 between the delta sigma modulator 41 and the analog LPF 42 of the DAC 40 shown in FIG. 4.

In addition, a digital audio source signal of the format of [1 Fs and 16 bit] of this case is input to a digital equalizer 31 of a DSP 30 and is input to the oversampling filter 44 of the DAC 40 in the same format of [1 Fs and 16 bit]. The oversampling filter 44 of this case receives a digital signal of the above-described format of [1 Fs and 16 bit] as input, converts the digital signal into a signal of the format of [16 Fs and 16 bit], and outputs the converted signal.

Then, the synthesizer 45 disposed inside the DAC 40 may need to combine digital signals of [16 Fs and 16 bit] together. Accordingly, a feedback signal output from an MFB-compliant digital signal processing unit 34 of this case should have not the format of [64 Fs and 16 bit] of the case shown in FIG. 4 but the format of [16 Fs and 16 bit]. Thus, the MFB-compliant digital signal processing unit 34 of this case may need to include a decimation process in which the sampling frequency of 16 Fs is output for the input sampling frequency of 64 Fs. In other words, the MFB-compliant digital signal processing unit 34 is configured so as to have a function for serving as the decimation filter 34e together with the original function for generating a feedback signal. As such a configuration, several configurations can be considered. However, as the most effective configuration, a configuration in which digital filters are directly used also as decimation filters by utilizing the configuration of the digital filters 34a and 34c of the MFB-compliant digital signal processing unit 34 that has the characteristics of an LPF may be considered. Similarly, the decimation filter has the characteristics of an LPF.

The synthesizer 45 combines a digital audio signal of the digital audio source oversampled to be [16 Fs and 16 bit] by the oversampling filter 44 with a feedback signal of [16 Fs and 16 bit] output from the MFB-compliant digital signal processing unit 34 for being added together. The synthesized signal is input to the delta sigma modulator 41. In the second embodiment, the MFB-compliant digital signal processing unit 34 outputs a feedback signal after inverting the phase of the feedback signal. Accordingly, the synthesizer 45 of this case may perform a synthesis process in which input signals are only added.

The delta sigma modulator 41 of this case does not convert an input signal into one bit, but converts the input signal into a signal of [16 Fs and 5 bit] of which the quantization bit rate is 5 bits. Then, the signal of [16 Fs and 5 bit] is input to the PWM modulator 43, and PWM modulation is performed for the signal. In addition, by passing the signal through the analog LPF 43, an analog audio signal is acquired as the output of the DAC 40. In other words, a configuration that is based on a class D amplifier is employed as a portion of the second embodiment for D/A conversion.

In addition, as a modified example of the second embodiment, the following can be considered. For example, the oversampling filter 44 is formed by connecting up-sampling circuits 46a to 46d in series on multiple stages, as shown in the figure. Here, each of the up-sampling circuits 46a to 46d converts the sampling frequency of an input signal to be doubled. Thus, by connecting such up-sampling circuits on four stages, an input signal of [1 Fs and 16 bit] can be output in the format of [16 (=2×2×2×2) Fs and 16 bit]. In addition, the MFB-compliant digital signal processing unit 34 converts an input signal having the sampling frequency of 64 Fs into a 16-bit signal having the sampling frequency of 8 Fs, 4 Fs or 2 Fs, which is lower than 16 Fs, to be output by using the decimation filter 34e. Then, this signal is configured to be input to a predetermined up-sampling circuit of the oversampling filter 44 in accordance with the sampling frequency.

For example, when the format of the feedback signal output from the MFB-compliant digital signal processing unit 34 is [8 Fs and 16 bit], a synthesizer 47c is inserted into the oversampling filter 44 to be disposed prior to the up-sampling circuit 46d. Thus, the synthesizer 47c is configured to combine the feedback signal output from the MFB-compliant digital signal processing unit 34 and the output of the up-sampling circuit 46c together and output the combined signal to the up-sampling circuit 47d. Under such a configuration, the digital audio source signal that is up-sampled up to [8 Fs and 16 bit] and the feedback signal of the same format of [8 Fs and 16 bit] output from the MFB-compliant digital signal processing unit 34 are combined together by the synthesizer 47c. Then, by passing the combined signal through the up-sampling circuit 46d, finally, the signal can be input to the delta sigma modulator 43 as an audio signal of [16 Fs and 16 bit] (in such a case, the synthesizer 42 may be omitted).

Similarly, when the format of the feedback signal output from the MFB-compliant digital signal processing unit 34 is [4 Fs and 16 bit], a synthesizer 47b is inserted into the oversampling filter 44 to be disposed prior to the up-sampling circuit 46c. Thus, the synthesizer 47b is configured to combine the output signal of the MFB-compliant digital signal processing unit 34 and the output of the up-sampling circuit 46c together and output the combined signal to the up-sampling circuit 47c. On the other hand, when the format of the feedback signal output from the MFB-compliant digital signal processing unit 34 is [2 Fs and 16 bit], a synthesizer 47a is inserted into the oversampling filter 44 to be disposed prior to the up-sampling circuit 46d. Thus, the synthesizer 47a is configured to combine the output signal of the MFB-compliant digital signal processing unit 34 and the output of the up-sampling circuit 46b together and output the combined signal to the up-sampling circuit 47b.

In such a modified example, the number of calculation steps, for example, corresponding to about one sampling period is increased. Accordingly, there is an advantage of implementing desired filtering characteristics without increasing the clock frequency of the system in a case where the necessary amount of calculation of the MFB-compliant digital signal processing unit 34 within one sampling period is increased.

In the first embodiment, the sampling frequency of the feedback signal output from the MFB-compliant digital signal processing unit 34 is described to be the same as the sampling frequency of a signal handled by the delta sigma modulator 41 disposed on the DAC 40 side. However, in the above-described modified example, the sampling frequency of the feedback signal is lower than the sampling frequency of the signal handled by the delta sigma modulator 41. However, when the up-sampling circuit disposed inside the oversampling filter 44 through which the feedback signal passes is considered to be included in the digital filter as its constituent portion, even in such a case, the sampling frequency of the feedback signal is the same as the sampling frequency of the signal handled by the delta sigma modulator 41 of the DAC 40. In addition, under the configuration of the modified example, the feedback signal passes through a part of the oversampling filter 41 of the DAC 40. Accordingly, a corresponding delay occurs, for example, compared to a case where the feedback signal does not pass through the oversampling filter 41. However, compared to a case where the feedback signal completely passes through the oversampling filter 12a as shown in FIG. 3, an advantage in that the amount of delay in the DAC 40 is decreased can be acquired.

### 6. Digital MFB Signal Processing System: Third Embodiment

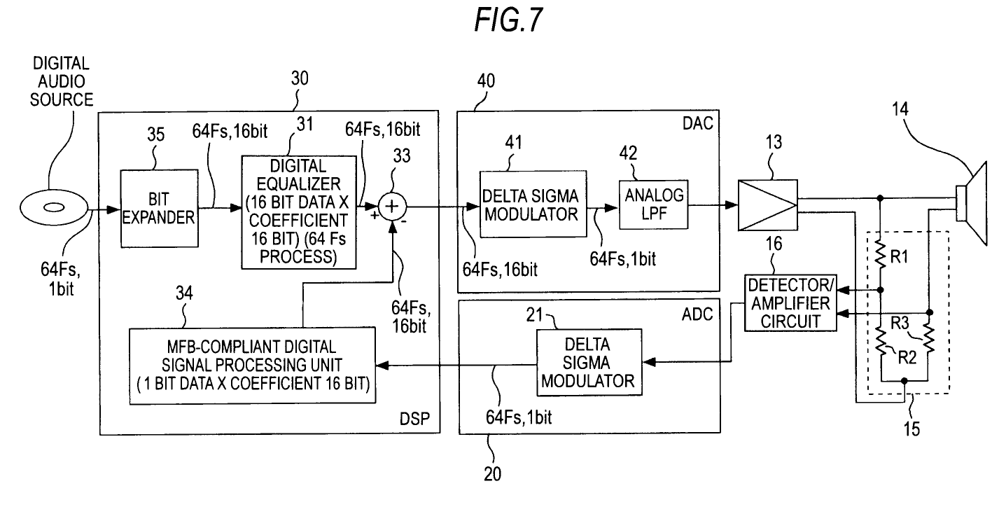

FIG. 7 shows a configuration example as a third embodiment. In the figure, the same reference numeral is assigned to each same portion as that shown in FIG. 4, and description thereof is omitted here. In the embodiments described until now, the digital audio source is assumed to be a digital audio source of a PCM type of [1 Fs and 16 bit] of a CD or the like. The format of the digital audio signal of [1 Fs and 16 bit] is currently one of main streams. However, other than that, like a digital audio signal having the format of [64 Fs and 1 bit], for example, that is recorded in an SACD (Super Audio CD) or the like, a signal having the format of a DSD (Direct Stream Digital) or the like corresponding to the format after delta sigma modulation is handled as a form of an audio content. As the third embodiment, a configuration example for a case where the digital audio source is in the DSD format is shown.

A DSP 30 shown in FIG. 7 is configured to include a bit expander 35, a digital equalizer 31, a synthesizer 33, and an MFB-compliant digital signal processing unit 34. This configuration, compared to that shown in FIG. 4, can be regarded as a signal processing configuration in which the bit expander 35 is newly added, and the oversampling filter 32 is omitted. In addition, the configurations of a DAC 40 and an ADC 20 are the same as those shown in FIG. 4.

A digital audio source shown in FIG. 7 is a signal having the DSD format of [64 Fs and 1 bit]. This signal is input to the bit expander 35 of the DSP 30. The bit expander 35 receives the signal of the digital audio source of [64 Fs and 1 bit] as input, converts the input signal into a signal of [64 Fs and 16 bit] by performing a 16-bit expansion process, and outputs the converted signal to the digital equalizer 31.

Here, the bit expansion process performed by the bit expander 35 represents a process of converting a one-bit signal having the DSD format, that is, a signal that can handle only binary values of 1 or 0 into 0xC000 (0.5) or 0xC000 (−0.5) that is formed of 16 bits. Accordingly, the bit expander 35 may be configured by a digital filter having LPF characteristics. Furthermore, the bit expander 35 may be configured to include a ROM as shown in FIG. 5B.

The digital equalizer 31 of this case receives a digital audio signal of the above-described format of [64 Fs and 16 bit] as input and performs a 16-bit calculation process. This calculation process is performed in accordance with a clock timing corresponding to 64 Fs. Then, the digital equalizer 31 outputs the digital audio signal after the equalizing process in the format of [64 Fs and 16 bit] that is the same as that on the input stage. The digital equalizer 31 outputs the above-described signal to the synthesizer 33.

As a comparison, in FIG. 4, the digital equalizer 31 is configured to receive a signal of [1 Fs and 16 bit], in correspondence with the format of the digital audio source signal of [1 Fs and 16 bit], and output a signal of the same format of [1 Fs and 16 bit]. Furthermore, the output of the digital equalizer 31 is converted into the format of [64 Fs and 16 bit] by the oversampling filter 32 and is output to the synthesizer 33. In other words, similarly to the example shown in FIG. 7, in a case where the digital audio signal is in the format of [64 Fs and 1 bit], the sampling frequency may be maintained to be 64 Fs on the input stage for the DSP 30, and thereby the oversampling filter 32 can be omitted. Instead of this, by performing bit expansion, the quantization bit rate of the audio signal is configured as 16 bits, which is the same as the feedback signal. In addition, the formats of the input and the output of the digital equalizer 31 are configured to be in correspondence with [64 Fs and 16 bit].

Then, the synthesizer 33 combines the digital audio signal of the format of [64 Fs and 16 bit] output from the digital equalizer 31 as described above with a phase-inverted feedback signal of the same format of [64 Fs and 16 bit] and outputs a resultant signal to the DAC 40.

As an actual device having the MFB signal processing system as this embodiment described until now, for example, there is an active speaker. In the active speaker, a signal processing and amplifying circuit that receives an audio signal as input and performs signal processing and signal amplification by receiving the supply of power and a speaker are integrally formed. In addition, this embodiment can be applied to an audio reproduction device in which a player reproducing a digital audio source and a speaker are integrally formed or the like. Furthermore, the configuration according to this embodiment can be applied to devices other than a single device that includes a speaker and an audio signal processing circuit as described above, for example, an audio component system or the like. For example, in the audio component system that is configured by a speaker unit and an amplifier, first, a sensor such as the bridge circuit 15 is disposed on the speaker unit side. In addition, on the amplifier side, a terminal used for receiving a signal from the sensor is disposed, and a signal input to this terminal is input to the detector/amplifier circuit 16. Furthermore, for example, the ADC 20, the DSP 30, the DAC 40, and the like represented in the embodiments described until now are included.

### 7. Example Applied to Headphone

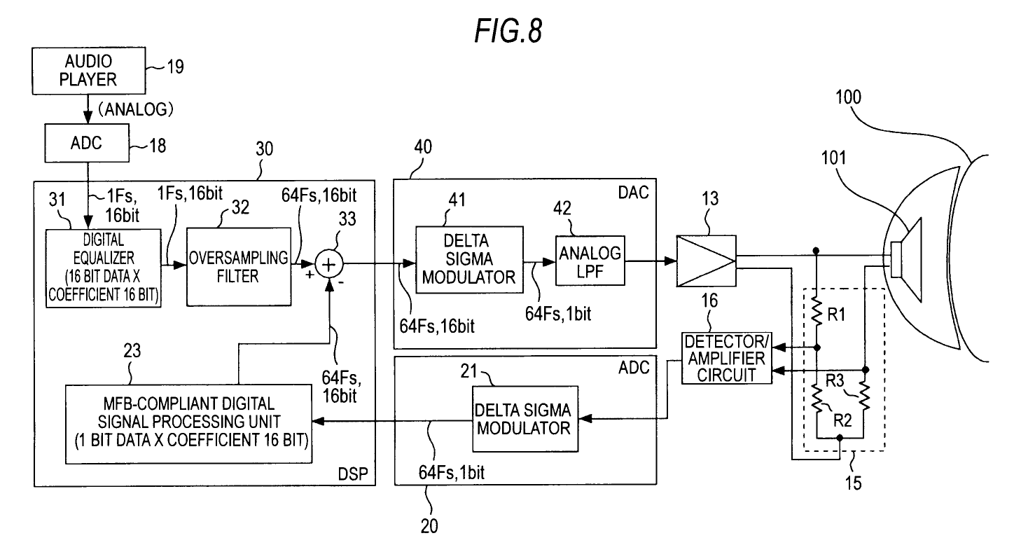

In headphones, a portion generally called a driver that converts an audio signal into sound by using a configuration equivalent to that of a speaker is included. From such a point, the configuration of the MFB signal processing system of this embodiment may be considered to be applied to the headphones. FIG. 8 shows a case where the configuration of the MFB signal processing system according to this embodiment is applied to an overhead-type headphone. In this figure, an ear pad corresponding to one ear (channel) is shown as the overhead-type headphone 100. In this overhead-type headphone 100, a driver 101 corresponding to the speaker unit 14 of the embodiments described until now is included. In this figure, as the configuration of the MFB signal processing system that drives the above-described driver by MFB control, the same configuration as that of the first embodiment shown in FIG. 4 is represented. However, instead of the configuration of the first embodiment, for example, the second and third configurations shown in FIGS. 6 and 7 maybe used. By applying the configuration of the MFB signal processing system of this embodiment to the headphone as described above, the advantages of the MFB signal processing system using digital circuits can be acquired in the listening environment of the headphone.

In a case where the MFB signal processing system of this embodiment is actually configured for a headphone, for example, first, the entire MFB signal processing system shown in FIG. 8 may be considered to be disposed on the headphone side. Such a configuration is assumed in the example shown in FIG. 8. In other words, in FIG. 8, an analog audio signal reproduced in an audio player 19 is converted into a digital signal by an ACD 18 and is input to a DSP 30. For example, the ADC 18 may be disposed on the headphone side. Under such a configuration, for example, the plug of the headphone 100 is connected to an analog audio signal output terminal of the audio player 19. As a result, the analog audio signal output from the audio player 19 is input to the ADC disposed on the headphone 100 side.

Alternatively, as another configuration for a case where the MFB signal processing system is applied to a headphone, the MFB signal processing system may be considered to be divided into parts on the headphone side and the audio player side. For example, a sensor as the bridge circuit 15 and the like is disposed on the headphone side, and the remaining components including the detector/amplifier circuit 16, the ADC 20, the DSP 30, the DAC 40, and the power amplifier 13 are disposed on the audio player side to which the headphone is connected.

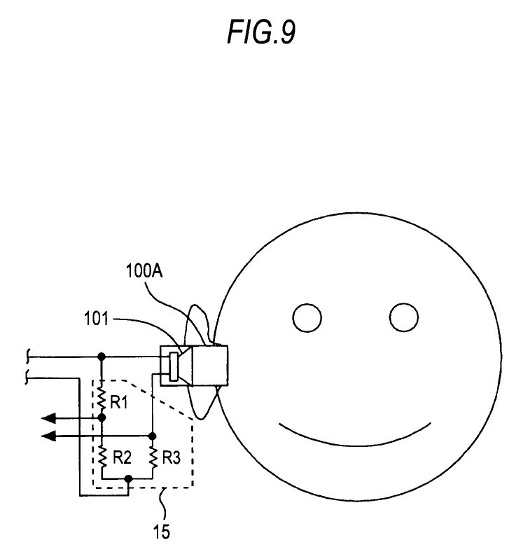

In addition, as a headphone, as represented as an in-ear type headphone 101 in FIG. 9, a type in which a unit portion of the driver 101 is put one around an auricle or is inserted into an occluded ear (also referred to as a kernel type) is known. The MFB signal processing system according to this embodiment can be also applied to such an in-ear type headphone 101 as shown in FIG. 8.

The present application contains subject matter related to that disclosed in Japanese Priority Patent Application JP 2009-140967 filed in the Japan Patent Office on Jun. 12, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A signal processing apparatus comprising:
analog-to-digital conversion means that receives an analog detection signal acquired by detecting a movement of a diaphragm of a speaker as input, converts the analog detection signal into a digital signal having a predetermined sampling frequency and a predetermined quantization bit rate that is equal to or greater than one bit by performing a first delta sigma modulation process, and outputs the digital signal;
signal processing means that receives the digital detection signal output from the analog-to-digital conversion means as input, generates a digital feedback signal, and outputs the digital feedback signal;
synthesis means that converts an input digital audio signal to have a same sampling frequency as the feedback signal and then combines the input digital audio signal with the feedback signal in a synthesis stage by combining the input digital audio signal to be reproduced as sound by the speaker with the feedback signal as negative feedback; and
digital-to-analog conversion means that is formed to have at least a portion for performing a second delta sigma modulation process in which the digital audio signal after combination with the feedback signal is input, and the digital audio signal is converted into a digital signal having a quantization bit rate b (b<a) at a predetermined sampling frequency f1 by receiving the digital audio signal having the sampling frequency f1 and a quantization bit rate a after combination with the feedback signal output from the synthesis means and performing conversion of the digital audio signal into an analog signal.

2. The signal processing apparatus according to claim 1,
wherein the signal processing means has a digital filter for generating the feedback signal, and
wherein the digital filter includes
a shift register having a predetermined number of taps to which sample data of a digital signal to be input to the digital filter is input, and
data processing means that maintains output data of a bit rate corresponding to the quantization bit rate of an output signal of the digital filter in a predetermined memory area in association with each address and reads out the output data corresponding to an address designated by the output of the shift register from the memory area and sets the output of the digital filter to the read-out output data.

3. The signal processing apparatus according to claim 2,
wherein the digital filter of the signal processing means is configured to have a function as a decimation filter, and
wherein the signal processing means includes up-sampling means that raises the sampling frequency of the input audio signal, with which the feedback signal output from the digital filter is combined, up to a sampling frequency to be input to the portion for performing the second delta sigma modulation process.

4. The signal processing apparatus according to claim 3,
wherein the digital-to-analog conversion means includes an oversampling filter that performs oversampling for the audio signal by using an up-sampling circuit in which stages of a predetermined number are connected together in series and inputs the oversampled audio signal to the portion for performing the second delta sigma modulation process, and
wherein the up-sampling circuit is formed by using at least one stage of the up-sampling circuit that is appropriate for the sampling frequency to be raised up to.

5. The signal processing apparatus according to claim 4,
wherein the synthesis means combines the digital audio signal output from a specific up-sampling circuit out of the up-sampling circuits of a plurality of stages with the feedback signal, and
wherein the decimation filter of the digital filter performs down-sampling such that the sampling frequency is the same as that of the digital audio signal output from the specific up-sampling circuit.

6. A signal processing method comprising the steps of:
receiving an analog detection signal acquired by detecting a movement of a diaphragm of a speaker as input, converting the analog detection signal into a digital signal having a predetermined sampling frequency and a predetermined quantization bit rate that is equal to or greater than one bit by performing a first delta sigma modulation process, and outputting the digital signal;
receiving the digital detection signal output in the converting of the analog detection signal, generating a digital feedback signal, and outputting the digital feedback signal;
converting an input digital audio signal to have a same sampling frequency and a quantization bit rate as the feedback signal and then combining the input digital audio signal with the feedback signal in a synthesis stage by combining the input digital input audio signal to be reproduced as sound by the speaker with the feedback signal as negative feedback; and
forming at least a portion for performing a second delta sigma modulation process in which the digital audio signal after combination with the feedback signal is input, and the digital audio signal is converted into a digital signal having a quantization bit rate b (b<a) at a predetermined sampling frequency f1 by receiving by receiving the digital audio signal having the sampling frequency f1 and a quantization bit rate a after combination with the feedback signal output in the converting of the input audio signal and performing conversion of the digital audio signal into an analog signal.

7. A signal processing apparatus comprising:
an analog-to-digital conversion unit configured to receive an analog detection signal acquired by detecting a movement of a diaphragm of a speaker as input, convert the analog detection signal into a digital signal having a predetermined sampling frequency and a predetermined quantization bit rate that is equal to or greater than one bit by performing a first delta sigma modulation process, and output the digital signal;
a signal processing unit configured to receive the digital detection signal output from the analog-to-digital conversion unit as input, generate a digital feedback signal, and output the digital feedback signal;
a synthesis unit configured to convert an input digital audio signal to have a same sampling frequency as the feedback signal and then combine the input digital audio signal with the feedback signal in a synthesis stage by combining the input digital audio signal to be reproduced as sound by the speaker with the feedback signal as negative feedback; and
a digital-to-analog conversion unit configured to be formed to have at least a portion for performing a second delta sigma modulation process in which the digital audio signal after combination with the feedback signal is input, and the digital audio signal is converted into a digital signal having a quantization bit rate b (b<a) at a predetermined sampling frequency f1 by receiving the digital audio signal having the sampling frequency f1 and a quantization bit rate a after combination with the feedback signal output from the synthesis unit and performing conversion of the digital audio signal into an analog signal.
